(19) United States
(12) Patent Application Publication
(10) Pub. No.: US 2020/0191311 A1
(43) Pub. Date: Jun. 18, 2020

(54) Piping Connection System

(71) Applicant: Joseph P. Marcilese, Simi Valley, CA (US)

(72) Inventor: Joseph P. Marcilese, Simi Valley, CA (US)

(21) Appl. No.: 16/719,384

(22) Filed: Dec. 18, 2019

Related U.S. Application Data
(60) Provisional application No. 62/796,416, filed on Jan. 24, 2019.
(60) Provisional application No. 62/781,429, filed on Dec. 18, 2018.

(51) Int. Cl. F16L 37/14

(52) U.S. Cl. CPC F16L 37/146; F16L 37/148

(57) ABSTRACT

A pipe connection system comprising interconnection elements and flow elements is presented. The interconnection elements of the system contain a cylindrical surface in which is formed an annular locking groove. The annular locking groove of is generally of the same radius of curvature as another, oppositely directed or mirror image, annular locking groove formed in the flow elements. When either a flow element is inserted into a flow passage of an interconnection element, an alignment feature controls the insertion depth of flow element into the interconnection element such that the annular locking groove of the flow element aligns with the oppositely curved annular locking groove of the interconnection element to form a locking annulus.

### CROSS-REFERENCES TO RELATED APPLICATION

This application claims the benefit of U.S. Provisional Application Ser. No. 62/781,429, filed Dec. 18, 2018 and entitled “Single-Use Piping/Connection System,” and U.S. Provisional Application Ser. No. 62,796,416, filed Jan. 24, 2019 and entitled “Single-Use Piping/Connection System”, which are incorporated herein by this reference.

### BACKGROUND OF THE INVENTION

### Field of the Invention

The present invention relates to interconnections for piping systems, and more particularly to a joint assembly that facilitates the interconnection of piping and system parts without the need for compression fittings, push-fit fittings, adhesives, brazing or welding.

### Background of the Invention

Piping systems exist to facilitate the flow of fluids. For example, homes, schools, medical and industrial facilities, commercial buildings and other occupied structures generally require integrated piping systems so that water and/or other fluids can be circulated for a variety of uses. Liquids and gasses such as cold and hot water, air, gases for medical and industrial use, cleaning chemicals, waste water, etc., are just some examples of the types of fluids and gases that can be deployed through piping systems. Tubing and piping types can include, for example, copper, brass and steel, and a wide variety of plastics including polyethylene and polypropylene, and glass fiber reinforced plastic materials, among others.

Piping connections or joints are necessary to join various pieces of pipe and must be versatile in order to adapt to changes of pipe direction required in particular piping system implementations. For example, fittings may be employed at the ends of open pieces of pipe that enable two pieces of pipe to fit together in a particular configuration. Among fitting types there are elbows, tees, ends and couplings adapted for various purposes.

In the past, metallic pipe elements have been traditionally connected by welding, brazing and/or soldering them together using a torch. Welding, brazing and soldering pipe fittings is time-consuming and labor intensive, however. In many applications, plastic piping has become popular as a replacement for metal pipes. Plastic pipes are generally of lighter weight and are generally easier to join than comparable metal pipes. Plastic pipes are commonly joined via threading and/or adhesives or by means of press-fit, push-fit or quick disconnect fittings. Press-fit, push-fit or quick disconnect fittings while relatively easy to use are often complex involving many internal components and can be relatively expensive.

While a number of pipe fittings and methods of joining pipes may be found in the art, there remains a need for a pipe connection system suitable for joining a wide variety of pipes of various materials and/or sizes, that is relatively low cost and may be installed quickly, without the need for special equipment.

### SUMMARY OF THE INVENTION

The present invention provides an improved pipe connection system that provides a secure connection between two or more pipe elements and is quick and easy to install without the need for special tools or training and is of relatively low cost to manufacture. The exemplary embodiment of the pipe connection system includes interconnection elements such as block elbow and block tee elements which are used to interconnect flow elements such as end fitting elements and pipe elements. With these elements, extensive and complex piping systems may readily be created. The pipe connection system of the present invention is well suited for joining pipe elements made from plastic materials or metallic materials, and for joining pipe elements made from dissimilar materials.

The components of the system may be scaled up or down to accommodate any desired pipe diameter. The interconnection elements may also be configured to accommodate pipes of different diameters as may be desired. The connection elements of the exemplary embodiment are presented as elbow and tee elements. However, the principles presented may be used to create “straight-through” interconnection elements for two pipe elements or to create interconnection elements for four or more pipe elements.

Functionally, the end fitting and pipe elements of the system contain a cylindrical exterior interface surface in which is formed an annular locking groove. The annular locking groove of the end fitting and pipe elements is generally of the same radius of curvature as another, oppositely directed or mirror image, annular locking groove formed on a cylindrical interior surface of a cylindrical flow passage of an interconnection element. When either an end element or a pipe element is telescopically engaged or inserted into a flow passage of an interconnection element, an alignment feature controls the insertion depth of the end or pipe element into the interconnection element such that the annular locking groove of the end or pipe element aligns with the oppositely curved annular locking groove of the interconnection element to form a locking annulus.

A flexible but substantially incompressible locking pin may then be inserted through a circular opening of a cylindrical passageway formed in the block elbow and block tee elements, proximate to each flow passage and which intersects with the locking annulus. Once inserted, the locking pin keeps the end element or pipe element from separating from the flow passage of the interconnection element into which it is inserted.

The above and other advantages of the piping connection system of the present invention will be described in more detail below.

### BRIEF DESCRIPTION OF THE DRAWINGS

FIG. 1 is a schematic, top plan view of a piping system depicting the components of the pipe fitting system of the present invention.

FIG. 2A is a right side view of a block elbow element in accordance with the pipe fitting system of the present invention.

FIG. 2B is front end view of the block elbow element of FIG. 2A.

FIG. 2C is a top view of the block elbow element of FIG. 2A.

FIG. 2D is cross-sectional view of the block elbow element taken along the line 1-1 of FIG. 2B.

FIG. 3A is a right side view of a block tee element in accordance with the pipe fitting system of the present invention.

FIG. 3B is front end view of the block tee element of FIG. 3A.

FIG. 3C is a top view of the block tee element of FIG. 3A.

FIG. 3D is cross-sectional view of the block tee element taken along the line 2-2 of FIG. 3B.

FIG. 4A is a front view of an end fitting element in accordance with the pipe fitting system of the present invention.

FIG. 4B is a cross-sectional view of the end fitting element of FIG. 4B taken along the line 3-3 of FIG. 4A.

FIG. 5A is a cross-sectional view taken along the line 5-5 of FIG. 1, with the locking pin removed.

FIG. SB is a cross-sectional view taken along the line 5-5 of FIG. 1, with the locking pin installed.

FIG. 6A is a cross-sectional view taken along the line 6-6 of FIG. 1, with the locking pin removed.

FIG. 6B is a cross-sectional view taken along the line 6-6 of FIG. 1, with the locking pin installed.

FIG. 7 is a perspective view of a locking pin in accordance with the present invention.

FIG. 8A is an end view of a pipe element in accordance with the present invention.

FIG. 8B is a cross-sectional view of the pipe element o in FIG. 8A taken along the line.

### DETAILED DESCRIPTION OF THE PREFERRED EMBODIMENTS

The present invention will now be described more fully hereinafter with reference to the accompanying drawings, in which preferred embodiments of the invention are shown. The invention may, however, may be embodied in many different forms and should not be construed as being limited to the embodiments set forth herein. Rather these embodiments are provided so that this disclosure will be thorough and complete, and will fully convey the scope of the invention to those skilled in the art. Like numbers refer to like elements throughout.

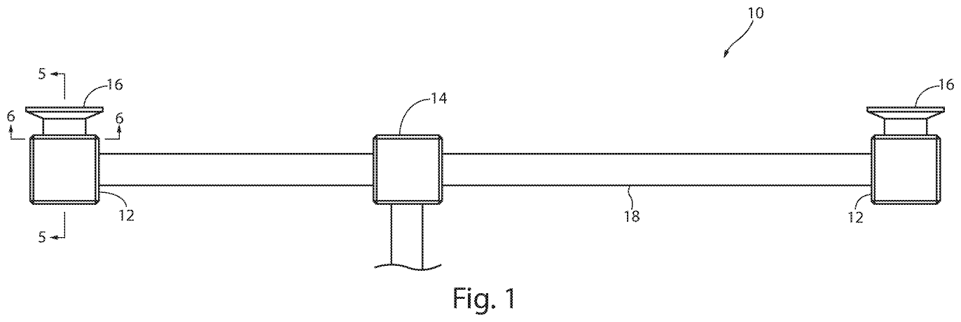

With reference to FIG. 1, a pipe fitting system 10 of the present invention is shown. The fitting system 10 comprises interconnection elements including block elbow elements 12 and block tee elements 14, and flow elements including end elements 16 and pipe elements 18, and flexible locking pins 20 (see FIG. 7). The block elbow elements 12 and block tee elements 14 are configured to telescopically engage or interconnect with the pipe elements 18 and end elements 16 and are secured to these elements via a pin element 20 (see FIG. 7).

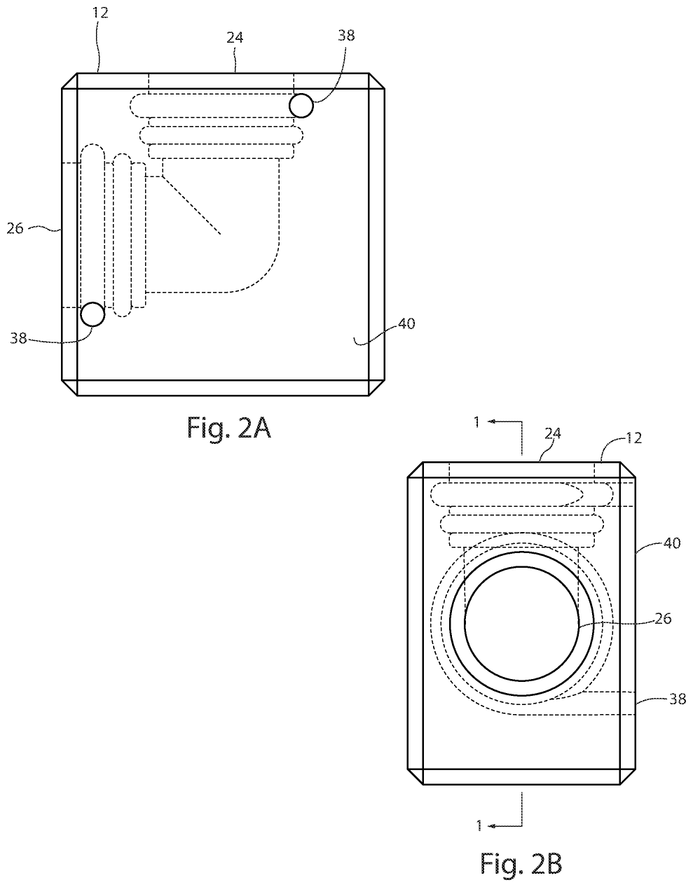

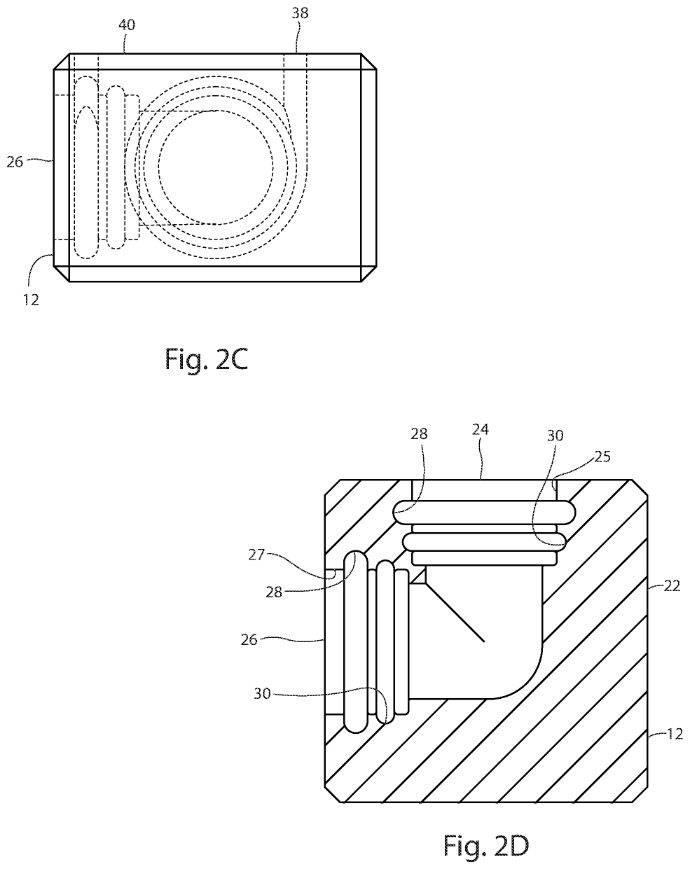

With reference to FIGS. 2A to 2D, the block elbow element 12 of the present invention is shown in more detail. The block elbow element 12 comprises a body element 22. The body element 22 has a first flow passage 24 having a cylindrical interior surface 25 and a second flow passage 26 having a cylindrical interior surface 27. The first flow passage 24 and the second flow passage 26 intersect such that a fluid or gas flowing in one flow passage will flow through to the other flow passage.

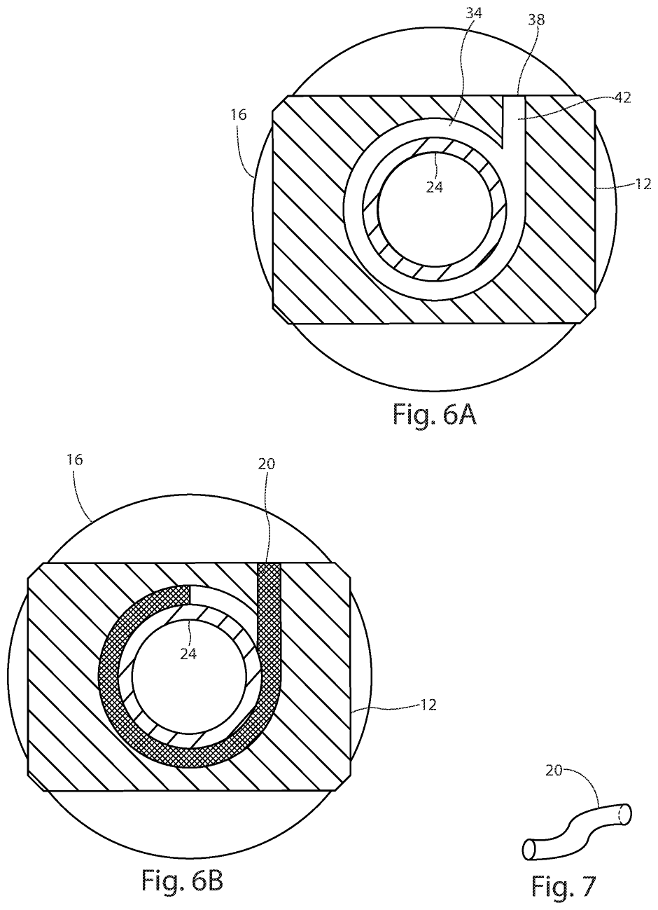

Formed on cylindrical interior surface 25 of the first flow passage 24 is an annular locking groove or recess 28, which in conjunction with an oppositely curved annular locking groove or recess 32 formed on the cylindrical engagement surface 44 of either a pipe element 18 or an end element 16, forms a locking annulus 34 (see FIG. 6A) for receipt of the locking pin 20. Formed on cylindrical interior surface 25 of the first flow passage 24 and disposed below the annular locking groove or recess 28 is an annular sealing groove or recess 30. The annular sealing groove or recess 30 serves to retain an o-ring seal 36 (see FIG. 6A).

Similarly, formed on the cylindrical interior surface 27 of the second flow passage 26 is another annular locking groove 28 which likewise forms a locking annulus 34 in conjunction with an opposite annular locking groove 32, where the opposite annular locking groove 32 is formed on the cylindrical engagement surface 44 of a pipe element 18 or an end element 16. The cylindrical interior surface 27 of the second flow passage 26 also contains another annular sealing groove 30, which likewise retains an o-ring seal 36.

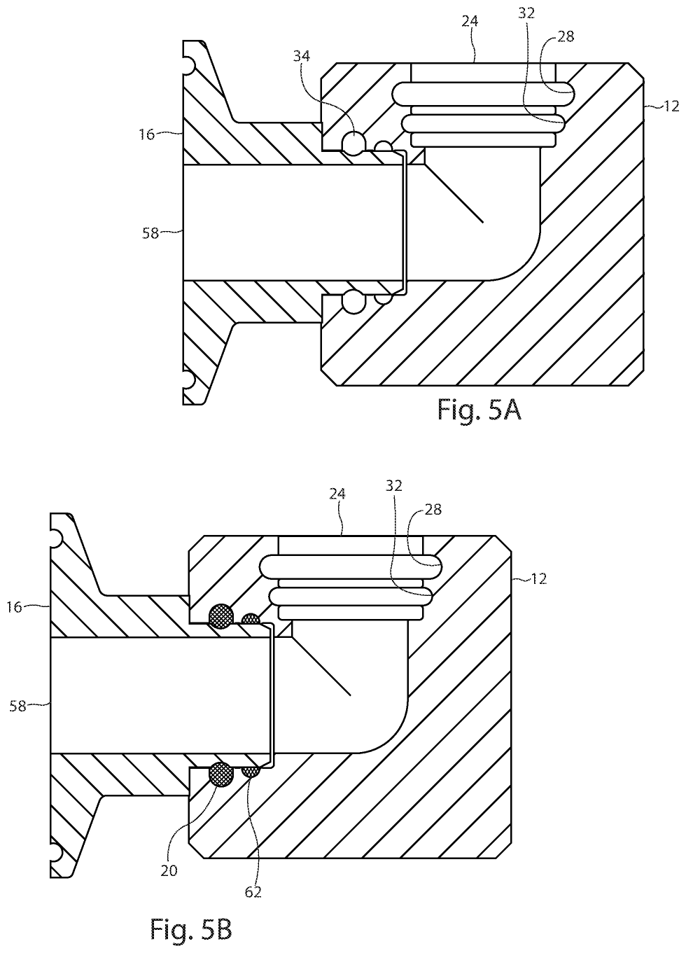

At the first flow passage 24, formed into a side wall 40 of the body element 22, and disposed perpendicular to the flow passage 24, is a cylindrical passageway 42 having a circular opening 38. (See FIG. 2C.) The cylindrical passageway 42 intersects with the annular locking groove 28 of the flow passage 24. When a cylindrical engagement surface 44 of either a pipe element 18 or an end element 16 is inserted within the first flow passage 24 of the elbow element 12, such that the annular locking groove 28 aligns with an opposite annular locking groove 32 of a pipe element 18 or an end element 16 to form the locking annulus 34, the cylindrical passageway 42 intersects the locking annulus 34. (See FIGS. 5A and 6A.) In this configuration, the flexible pin 20 may be inserted into the passageway 42 and pushed such that the flexible pin 20 slides into and engages the locking annulus 34. (See FIGS. 5B and 6B.) Once inserted, the flexible locking pin locks the pipe element 18 or end element 16 to the first flow passage 24 of the elbow element 12. The flexible locking pin 20 is made from a flexible but substantially incompressible material.

Similar to the first flow passage 24, at the second flow passage 26, formed into a side wall 40 of the body element 22, and disposed perpendicular to the flow passage 26, is another cylindrical passageway 42 having a circular opening 38. (See FIG. 2C.) The cylindrical passageway 42 again intersects with the annular locking groove 28 of the flow passage 26. Likewise, when an engagement surface 44 of either a pipe element 18 or an end element 16 is inserted within the second flow passage 26 such that the annular locking groove 28 aligns with an opposite annular locking groove 32 of a pipe element 18 or an end element 16 to form a locking annulus 34, the cylindrical passageway 42 intersects the locking annulus 34. (See FIGS. 5A and 6A.) Likewise, in this configuration, the flexible pin 20 may be inserted into the passageway 42 and pushed such that the flexible pin 20 slides into and engages the locking annulus 34. (See FIGS. 5B and 6B.) Once inserted, the flexible locking pin locks the pipe element 18 or end element 16 to the second flow passage 26 of the elbow element 12.

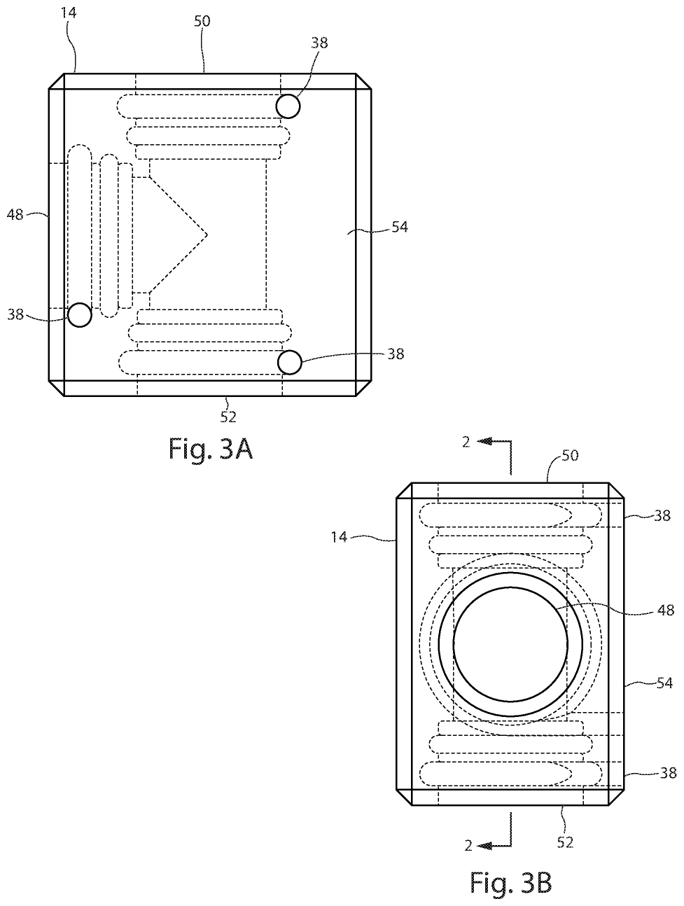

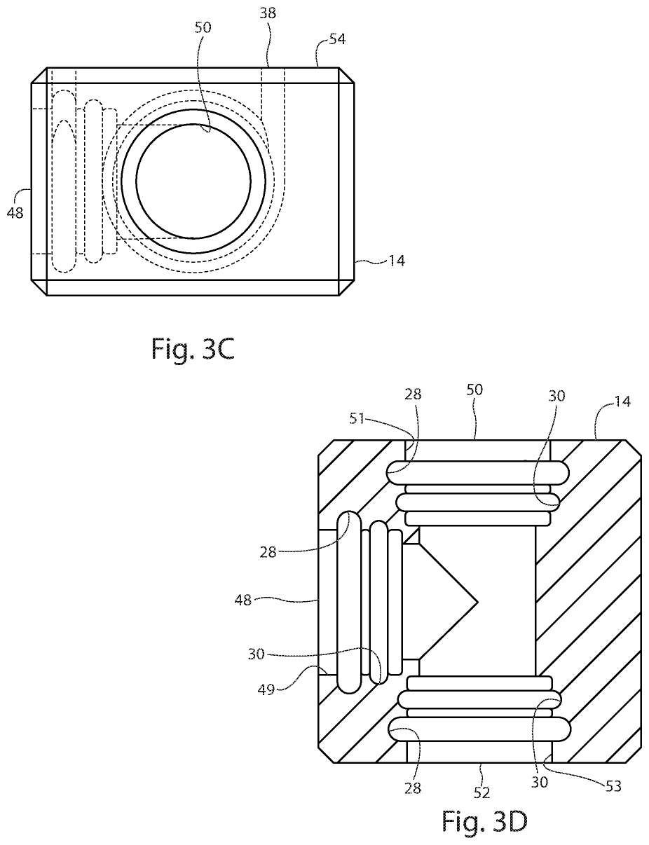

With reference to FIGS. 3A to 3D, the block tee element 14 of the present invention is shown in more detail. The block tee element 14 is similar to the block elbow element 12, but instead of two intersecting flow passages as found in the block elbow element, has three intersecting flow passages where one of the three flow passages is formed at a right angle to the other two flow passages, thereby giving this element its “tee” configuration. The annular locking grooves and sealing grooves are of the same configuration as those found in the block elbow element and likewise function similarly.

The block tee element 14 comprises a body element 46. The body element 46 has a first flow passage 48 having a cylindrical interior surface 49, a second flow passage 50 having a cylindrical interior surface 51, and a third flow passage 52 having a cylindrical interior surface 53. The second and third flow passages 50 and 52 intersect and are in axial alignment. The first flow passage 48 intersects the second and third flow passages 50 and 52 at a right or 90 degree angle. Consequently, each of the three flow passages can serve as an inlet with the other two flow passages serving as outlets or any two of the flow passages may serve as inlets with the other serving as an outlet. Each of the first, second and third flow passages 48, 50 and 52 is generally cylindrical.

Formed on the cylindrical interior surfaces of 49, 51 and 53 of each of the first, second and third flow passages, 48, 50 and 52, is an annular locking groove 28. The annular locking groove 28 in conjunction with an opposite annular locking groove 32 formed on the cylindrical engagement surface 44 of a pipe element 18 or an end element 16, forms a locking annulus 34. (See FIG. 6A.) Formed on the cylindrical interior surfaces 49, 51 and 53 of each of the first, second and third flow passages 48, 50 and 52 and disposed below each of the annular locking grooves 28 is an annular sealing groove 30. The annular sealing groove 30 serves to retain an o-ring seal 36. (See FIG. 6A).

At each of the first, second and third flow passages 48, 50 and 52, formed into a side wall 54 of the body element 46, and disposed perpendicular to the flow passages, is a cylindrical passageway 42 having a circular opening 38. (See FIG. 3C.) The cylindrical passageways 42 intersect the annular locking grooves 28 of the first, second and third flow passages 48, 50 and 52. When a cylindrical engagement surface 44 of either a pipe element 18 or an end element 16 is inserted within a flow passage of the block tee element 14, such that an annular locking groove 28 aligns with an opposite annular locking groove 32 of the pipe element 18 or end element 16 to form the locking annulus 34, the cylindrical passageway 42 intersects the locking annulus 34. (See FIGS. 5A and 6A.) As with the block elbow element 12, in this configuration, the flexible pin 20 may be inserted into the passageway 42 and pushed such that the flexible pin 20 slides into and engages the locking annulus 34. (See FIGS. 5B and 6B.) Once inserted, the flexible locking pin 20 locks the pipe element 18 or end element 16 to the particular flow passage of the block tee element 14 to which it is inserted.

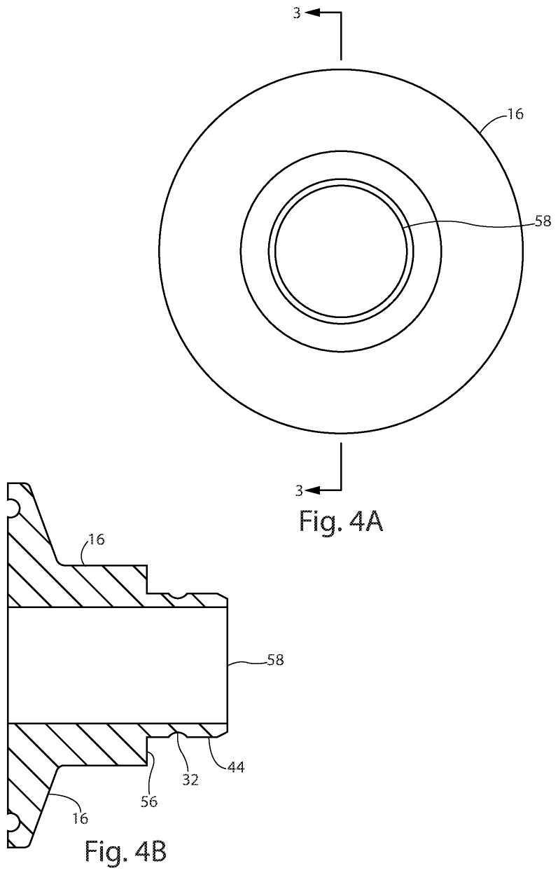

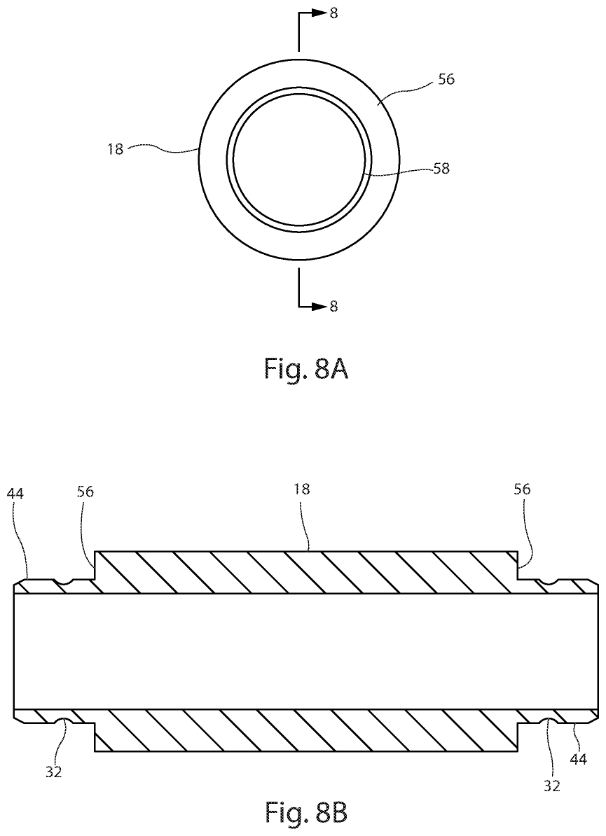

With reference to FIGS. 4A and 4B and 8A and 8B, an end element 16 (FIGS. 4A and 4B) and a pipe element 18 (FIGS. 8A and 8B) are shown. The end element 16 and the pipe element 18 each have a generally cylindrical bore 58. Each end of the pipe element 18 and a first end 60 of the end element 16 includes a generally cylindrical exterior surface or cylindrical engagement surface 44. The cylindrical engagement surface 44 is sized to be a slip fit with the cylindrical interior surfaces 25 and 27 of the flow passages 24 and 26 of the block elbow element 12 and the cylindrical interior surfaces 49, 51 and 53 of the flow passages 48, 50 and 52 of the block tee element 14. The cylindrical engagement surface 44 seals against an o-ring seal 62 retained in the annular grooves 30 in the flow passages of the block elbow element 12 and block tee element 14. (See FIGS. 5B and 6B.) The o-ring seal 62 prevents fluid, i.e. liquid or gas, from leaking at the interface between an end element 16 or a pipe element 18 and the flow passage of a block elbow or block tee element into which it is inserted.

Formed in the cylindrical engagement surfaces 44 of both the end element 16 and the pipe element 18 is an annular locking groove 32. The annular locking groove 32 is of the same radius of curvature as the annular locking groove 28 formed in the cylindrical flow passages 24 and 26 of the block elbow element 12 and the cylindrical flow passages 48, 50 and 52 of the block tee element 14. When either an end element 16 or a pipe element 18 is inserted into a flow passage of a block elbow element 12 or block tee element 14, an abutment surface 56 controls the insertion depth of the cylindrical engagement surface 44 such that the annular locking groove 32 aligns with the oppositely curved annular locking groove 28 of the flow passage to form the locking annulus 34. (See FIG. 6A.) The flexible but substantially incompressible locking pin 20 may then be inserted through the circular opening 38 of the cylindrical passageway 42, (found in the block elbow and block tee elements, proximate to each flow passage (see FIG. 6A)), which intersects the locking annulus 34. (See FIGS. 5B and 6B.) Once inserted, the locking pin 20 keeps the end element 16 or pipe element 18 from separating from the flow passage of the block elbow element 12 or block tee element 14 into which it is inserted.

With reference to FIG. 1, a pipe connection system 10 has been presented. The system includes the block elbow and block tee elements 12 and 14 which are used to interconnect the end elements 16 and pipe elements 18. With these elements, extensive and complex piping systems may readily be created. The pipe connection system presented is particularly well suited for joining pipe elements made from plastic materials and is equally well suited for joining piping elements made from dissimilar materials. The components of the system may be scaled up or down to accommodate any desired pipe diameter. The block elbow elements 12 and block tee elements 14 may also be configured to accommodate pipes of different diameters as may be desired. The connection elements of the exemplary embodiment are presented as elbow and tee elements. However, the principles presented may be used to create “straight-through” interconnection elements for two pipe elements and may be used to create interconnection elements for four or more pipe elements.

The block elbow, block tee, end and pipe elements may be made from a variety of plastic materials such as polypropylene and polyethylene, as well as a variety of glass reinforced plastic materials. These elements can likewise be made from a variety of metallic materials such as steel, aluminum and brass, for example.

The foregoing detailed description and appended drawings are intended as a description of the presently preferred embodiment of the invention and are not intended to represent the only forms in which the present invention may be constructed and/or utilized. Those skilled in the art will understand that modifications and alternative embodiments of the present invention which do not depart from the spirit and scope of the foregoing specification and drawings, and of the claims appended below are possible and practical. It is intended that the claims cover all such modifications and alternative embodiments.

1. A piping connection system, comprising:
a flow element having a cylindrical bore and a cylindrical exterior surface;
an interconnection element having a cylindrical flow passage having a cylindrical interior surface;
wherein the cylindrical exterior surface of the flow element is telescopically engagable with the cylindrical interior surface of the flow passage of the interconnection element;
wherein the interconnection element includes an annular groove formed on the cylindrical interior surface and wherein the flow element has an opposed annular groove annular groove formed upon the cylindrical exterior surface;
means for controlling a depth of insertion of the cylindrical exterior surface of the flow element within the cylindrical interior surface of the interconnection element, wherein the depth of insertion is controlled such that the annular groove formed on the cylindrical interior surface aligns with the opposed annular groove formed on the cylindrical exterior surface to form an annulus;
a cylindrical passageway formed within the interconnection element and oriented perpendicular to the flow passage and intersecting the annulus formed when the cylindrical exterior surface of the flow element is inserted into the cylindrical interior surface of the interconnection element; and
a flexible but substantially incompressible pin, wherein the pin is insertable into the passageway and the annulus, for locking the flow element to the interconnection element.

2. The piping connection system of claim 1 wherein the cylindrical interior surface of the flow passage includes an additional annular groove which retains an o-ring seal.

3. The piping connection system of claim 1 wherein the means for controlling the insertion depth is an abutment surface formed on the flow element.

4. The piping connection system of claim 1 wherein the interconnection element includes a plurality of flow passages.

5. The piping connection system of claim 4 wherein the plurality of flow passages intersect at a common point within the interconnection element.

6. The piping connection system of claim 1 wherein the flow element is selected from the group consisting of pipe elements and end elements.

7. The piping connection system of claim 1 wherein the interconnection element. is selected from the group consisting of elbow and tee elements.

8. A piping connection system, comprising;
a flow element having a cylindrical bore and a cylindrical exterior surface;
an interconnection element having a cylindrical flow passage having a cylindrical interior surface;
wherein the cylindrical exterior surface of the flow element is telescopically engagable with the cylindrical interior surface of the flow passage of the interconnection element;
wherein the interconnection element includes an annular locking groove formed on the cylindrical interior surface and wherein the flow element includes an opposed annular locking groove formed upon the cylindrical exterior surface;
wherein the interconnection element includes an annular sealing groove formed on the cylindrical interior surface and wherein the annular sealing groove retains an o-ring seal;
means for controlling a depth of insertion of the cylindrical exterior surface of the flow element within the cylindrical interior surface of the interconnection element, wherein the depth of insertion is controlled such that the annular groove formed on the cylindrical interior surface aligns with the opposed annular groove formed on the cylindrical exterior surface to form an annulus;
a cylindrical passageway formed within the interconnection element and oriented perpendicular to the flow passage and intersecting the annulus formed when the cylindrical exterior surface of the flow element is inserted into the cylindrical interior surface of the interconnection element; and
a flexible but substantially incompressible pin, wherein the pin is insertable into the passageway and the annulus, for locking the flow element to the interconnection element.

9. The piping connection system of claim 8 wherein the sealing groove formed on the cylindrical interior surface of the flow passage is disposed axially inward of the annular locking groove formed on the cylindrical interior surface.

10. The piping connection system of claim 8 wherein the means for controlling the insertion depth is an abutment surface formed on the flow element.

11. The piping connection system of claim 8 wherein the interconnection element includes a plurality of flow passages.

12. The piping connection system of claim 11 wherein the plurality of flow passages intersect at a common point within the interconnection element.

13. The piping connection system of claim 8 wherein the flow element is selected from the group consisting of pipe elements and end elements.

14. The piping connection system of claim 8 wherein the interconnection element. is selected from the group consisting of elbow and tee elements.

15. A piping connection system, comprising:
a plurality of flow elements, each flow element having a cylindrical bore and a cylindrical exterior surface;
an interconnection element having a plurality of cylindrical flow passages, wherein the flow passages intersect at a common point and each flow passage has a cylindrical interior surface;
wherein the cylindrical exterior surface of each flow element is telescopically engagable with the cylindrical interior surface of each flow passage;
wherein each flow passage includes an annular groove formed on the cylindrical interior surface and wherein each flow element has an opposed annular groove annular groove formed upon the cylindrical exterior surface;
means for controlling a depth of insertion of each cylindrical exterior surface within each cylindrical interior surface, wherein the depth of insertion is controlled such that the annular groove formed on each cylindrical interior surface aligns with the opposed annular groove formed on each cylindrical exterior surface to form an annulus;
each flow passage having a corresponding cylindrical passageway formed within the interconnection element, wherein the cylindrical passageway is oriented perpendicular to the corresponding flow passage such that the passageway intersects the annulus formed when each cylindrical exterior surface is inserted into each cylindrical interior surface; and
a flexible but substantially incompressible pin, wherein the pin is insertable into the passageway and the annulus, for locking the flow element to the flow passage of the interconnection element.

16. The piping connection system of claim 15 wherein the cylindrical interior surface of the flow passage includes an additional annular groove which retains an o-ring seal.

17. The piping connection system of claim 16 wherein the sealing groove formed on the cylindrical interior surface of the flow passage is disposed axially inward of the annular locking groove formed on the cylindrical interior surface.

18. The piping connection system of claim 15 wherein the flow element is selected from the group comprising pipe elements and end elements.

19. The piping connection system of claim 15 wherein the interconnection element is selected from the group comprising elbow and tee elements.

20. The piping connection system of claim 15 wherein the means for controlling the insertion depth is an abutment surface formed on the flow element.
